(19) United States
(12) Patent Application Publication
(10) Pub. No.: US 2006/0104320 A1
(43) Pub. Date: May 18, 2006

(54) Method and apparatus for forming a plurality of laser beams with ultraviolet wavelength, and laser machining apparatus

(75) Inventors: Goichi Ohmae, Ebina-shi (JP); Hiroshi Aoyama, Ebina-shi (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI VIA MECHANICS LTD., Ebina-shi (JP)

(21) Appl. No.: 11/274,273

(22) Filed: Nov. 16, 2005

(30) Foreign Application Priority Data
Nov. 16, 2004 (JP) 2004-331548

(51) Int. Cl. H01S 3/10

(52) U.S. Cl. 372/22

(57) ABSTRACT

The invention provides a method and an apparatus for forming a plurality of ultraviolet-wavelength laser beams, and a laser machining apparatus, in which the machining efficiency can be improved due to easy maintenance and inspection while deterioration of wavelength conversion means can be prevented to reduce the running cost. A laser beam with a near infrared wavelength output from a laser oscillator is branched into a plurality of laser beams by a laser distribution unit. Each branched laser beam is partially converted into a laser beam whose wavelength is ½ of the near infrared wavelength by a wavelength converter. An ultraviolet laser beam whose wavelength is ⅓ of the near infrared wavelength of the laser beam is formed out of the branched laser beam and the laser beam with the wavelength which is ½ of the near infrared wavelength by another wavelength converter, both the branched laser beam and the laser beam with the wavelength which is ½ of the near infrared wavelength being output from the wavelength converter. The ultraviolet laser beam is extracted and supplied to a portion to be machined, by a wavelength separator.

### FIELD OF THE INVENTION

The present invention relates to a method and an apparatus for forming a plurality of laser beams with ultraviolet wavelengths, and a laser machining apparatus.

### DESCRIPTION OF THE BACKGROUND ART

CO₂ lasers and ultraviolet lasers are chiefly used as lasers for use in laser machining apparatus for machining printed circuit boards. Generally, CO₂ lasers are used for machining holes with diameters not smaller than 50 μm, and ultraviolet lasers are used for machining holes with diameters not larger than 50 μm.

In recent years, with increase in mounting density of electronic parts, it has been requested to machine holes with diameters not larger than 50 μm at a high speed. Thus, there is an increasing demand for high-power and high-repeatable ultraviolet lasers (for example, with an average output power of 10 W or higher and a pulse repetition frequency of 100 kHz or higher).

In ultraviolet laser beam generation, a nonlinear optical crystal such as an LBO (lithium triborate; chemical formula LiB₃O₅) crystal or a CLBO (cesium lithium borate; chemical formula CsLiB₆O₁₀) crystal is used as a wavelength converter so as to convert a laser beam with a near infrared wavelength into a laser beam with an ultraviolet wavelength.

FIG. 3 is a configuration diagram of a background-art ultraviolet laser output apparatus for use in a laser machining apparatus.

An ultraviolet laser output apparatus 100 is constituted by a laser oscillator 1 and a laser forming unit 50. The laser oscillator 1 (e.g. a solid-state laser using Nd (neodymium) ions as gain media) outputs a pulsed laser beam 2a (hereinafter referred to as “fundamental wave”) having a near infrared wavelength of 0.7-2 μm (1.064 μm in the solid-state laser using Nd ions as gain media) and having a high average output power.

A wavelength converter 3 of the laser forming unit 50 converts a part of the laser beam 2a input thereto into a second harmonic 2b whose wavelength is ½ of the wavelength of the laser beam 2a. A wavelength converter 4 converts the fundamental wave 2a and the second harmonic 2b into a third harmonic 2t (hereinafter referred to as “ultraviolet laser beam”) whose wavelength is ⅓ of the wavelength of the laser beam 2a. A wavelength separator 5 separates a laser beam input thereto into the ultraviolet laser beam 2t and the other laser beam (including the fundamental wave 2a and the second harmonic 2b) 7.

Next, the operation of the ultraviolet laser output apparatus 100 will be described.

When a fundamental wave 2a with a near infrared wavelength output from the laser oscillator 1 passes through the wavelength converter 3, a part of the fundamental wave 2a is converted into a second harmonic 2b. When a mixed wave 7 in which the fundamental wave 2a and the second harmonic 2b are mixed passes through the wavelength converter 4, a part of the mixed wave 7 is converted into an ultraviolet laser beam 2t. A mixed wave 8 in which the fundamental wave 2a, the second harmonic 2b and the ultraviolet laser beam 2t are mixed is output from the wavelength converter 4. The mixed wave 8 is separated into the ultraviolet laser beam 2t and the other laser beam 7 by the wavelength separator 5. Then, a portion to be machined is irradiated with the ultraviolet laser beam 2t, while the other laser beam 7 is incident on a laser attenuator 6 so as to be converted into heat (Patent Document 1).

In machining requiring high pulse energy, the ultraviolet laser beam 2t separated by the wavelength separator 5 is used as it is. However, in machining with low pulse energy, the ultraviolet laser beam 2t is branched into n branched beams 2td by a laser distribution unit 9 (for example, beam splitter) as shown in FIG. 3. Machining is performed by each branched beam 2td.

The performance of the wavelength converter 4 deteriorates gradually due to incidence of laser beams. Therefore, for example, the surface area of the wavelength converter 4 is increased sufficiently as compared with the spot size of an incident beam, and the wavelength converter 4 is placed on a mount movable perpendicularly to the optical axis of the beam. When the performance of the wavelength converter 4 deteriorates, a new face thereof is disposed on the optical axis so as to prevent the machining efficiency from deteriorating (Patent Document 2).

Patent Document 1:

Japanese Patent Laid-Open No. 2004-220051

Patent Document 2:

Japanese Patent Laid-Open No. 2004-022946

A crystal for generating ultraviolet rays is required to be characterized in that self-heating caused by absorption of ultraviolet rays generated in the crystal is low and that the outgoing surface of the crystal is hardly damaged by the ultraviolet rays.

When the average output power of a laser beam incident on a wavelength converter is low, or when the wavelength of the output laser beam is visible, there is no problem as to temperature rise in the wavelength converter caused by absorbing the laser beam. However, when the value of temperature rise exceeds an allowable value due to highly repeated incidence of a laser beam with a high output power (e.g. the output power is several watts or several tens of watts and the wavelength is close to an ultraviolet band), phase matching conditions are put in disorder due to the temperature dependence of the refractive index of the crystal so that the conversion efficiency is lowered, with the result that the machining quality is lowered. This phenomenon appears more conspicuously with increase of the output power of the generated ultraviolet laser beam.

### SUMMARY OF THE INVENTION

In order to solve the problem in the background art, an object of the invention is to provide a method and an apparatus for forming a plurality of laser beams with an ultraviolet wavelength, and a laser machining apparatus, in which the machining efficiency can be improved due to easy maintenance and inspection while deterioration of wavelength conversion means can be prevented to reduce the running cost.

In order to achieve the foregoing object, according to a first configuration of the invention, there is provided a method for forming a plurality of laser beams with an ultraviolet wavelength, the ultraviolet-wavelength laser beams being formed by wavelength conversion of a laser beam with a near infrared wavelength, the method including the steps of: branching a laser beam with a near infrared wavelength or each of laser beams whose wavelength is ½ of the near infrared wavelength into a plurality of laser beams; and converting wavelengths of the plurality of branched laser beams individually so as to form a plurality of laser beams with an ultraviolet wavelength.

According to a second configuration of the invention, there is provided an apparatus for forming a plurality of laser beams with an ultraviolet wavelength, the apparatus including: a laser oscillator for outputting a first laser beam with a near infrared wavelength; a branching means for branching the first laser beam into a plurality of branched first laser beams; first wavelength conversion means for converting a part of the branched first laser beams into second laser beams whose wavelength is ½ of the near infrared wavelength of the first laser beam; and second wavelength conversion means for forming laser beams with an ultraviolet wavelength which is ⅓ of the near infrared wavelength of the first laser beam, out of the second laser beams output from the first wavelength conversion means and the branched first laser beams which have not been converted in wavelength by the first wavelength conversion means; wherein: after the first laser beam is branched into a plurality of branched first laser beams by the branching means, the plurality of branched first laser beams are formed into laser beams with an ultraviolet wavelength individually by the first and second wavelength conversion means.

According to a third configuration of the invention, there is provided an apparatus for forming a plurality of laser beams with an ultraviolet wavelength, the apparatus including: a laser oscillator for outputting a first laser beam with a near infrared wavelength; two wavelength conversion means for converting the first laser beam incident thereon into a laser beam whose wavelength is ½ of the near infrared wavelength of the first laser beam; and a branching means for branching an incident laser beam into a plurality of laser beams; wherein: the first laser beam with the near infrared wavelength is converted into a second laser beam whose wavelength is ½ of the near infrared wavelength by one of the wavelength conversion means; the second laser beam is then branched into a plurality of branched second laser beams by the branching means; and the branched second laser beams are formed into laser beams with an ultraviolet wavelength which is ½ of the wavelength of the second laser beam by the other wavelength conversion means.

According to a fourth configuration of the invention, there is provided a laser machining apparatus including: a laser oscillator for outputting a first laser beam with a near infrared wavelength; a plurality of pieces of forming apparatus for forming a plurality of laser beams with an ultraviolet wavelength according to the third or fourth configuration of the invention; and laser positioning means; wherein: the first laser beam with the near infrared wavelength output from the laser oscillator is formed into a plurality of laser beams with an ultraviolet wavelength by the forming apparatus, and the plurality of formed laser beams with the ultraviolet wavelength are positioned individually by the positioning means so as to perform machining.

The machining efficiency can be improved due to easy maintenance and inspection, while deterioration of the wavelength conversion means can be prevented to reduce the running cost.

### BRIEF DESCRIPTION OF THE DRAWINGS

FIG. 1 is a main portion configuration diagram of a laser machining apparatus having a wavelength conversion unit according to the invention;

FIG. 2 is a main portion configuration diagram of another laser machining apparatus having a wavelength conversion unit according to the invention; and

FIG. 3 is a configuration diagram of a background-art ultraviolet laser output apparatus.

### DETAILED DESCRIPTION OF THE INVENTION

The invention will be described below in detail with reference to the drawings.

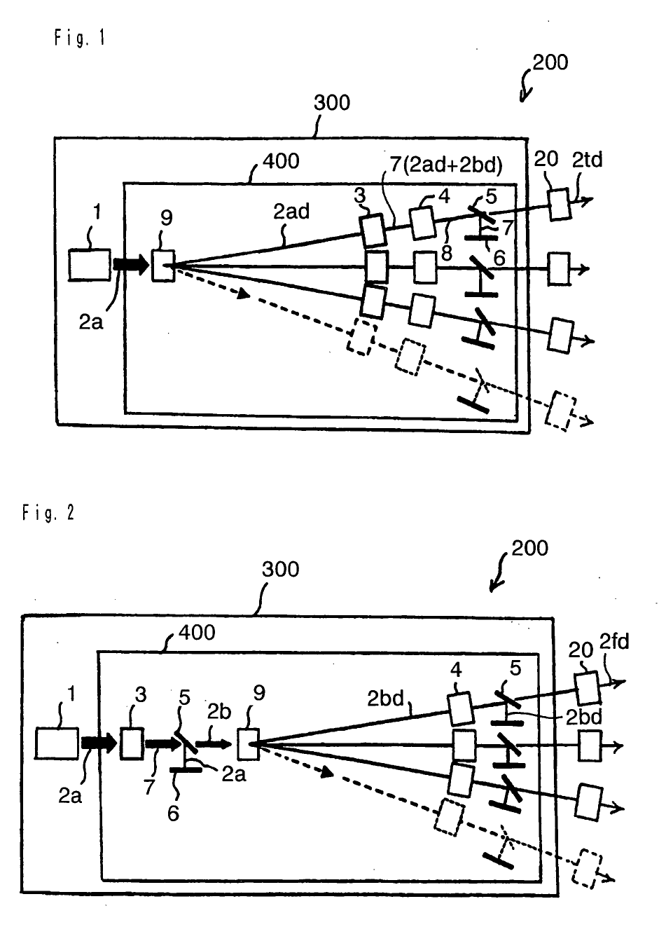

FIG. 1 is a main portion configuration diagram of a laser machining apparatus having a wavelength conversion unit according to a first embodiment of the invention. Parts the same as or functionally the same as those in FIG. 3 are denoted by the same reference numerals correspondingly, and redundant description thereof will be omitted.

A laser machining apparatus 200 is constituted by an ultraviolet laser output unit 300, a laser positioning unit 20, and a not-shown work moving unit disposed in a position opposed to the laser positioning unit 20.

The ultraviolet laser output unit 300 is constituted by a laser oscillator 1 and a laser forming unit 400. The laser oscillator 1 is a solid-state laser using Nd ions as gain media and outputting a high-power near infrared pulsed fundamental wave 2a with a wavelength of 1.064 μm.

The laser forming unit 400 is constituted by a laser distribution unit 9, wavelength converters 3 and 4, wavelength separators 5 and laser attenuators 6. The wavelength converters 3 and 4 are provided for each ultraviolet laser beam to be output, as will be described later.

The laser positioning unit 20 is, for example, constituted by a pair of galvanometer scanners and an fθ lens.

Next, the operation of this embodiment will be described.

The fundamental wave 2a output from the laser oscillator 1 is branched into n (n≧2, 3 in FIG. 1) beams 2ad by the laser distribution unit 9. Each branched beam 2ad passing through the corresponding wavelength element 3 is partially converted into a second harmonic 2b. A mixed wave 7 in which the fundamental wave 2a and the second harmonic 2b are mixed passes through the corresponding wavelength converter 4 so as to be partially converted into an ultraviolet laser beam 2td whose wavelength is ⅓ of the fundamental wave 2a. A mixed wave 8 in which the fundamental wave 2a and the second harmonic 2b (i.e. the mixed wave 7) and the ultraviolet laser beam 2td are mixed is separated into the ultraviolet laser beam 2td and the mixed wave 7 by the corresponding wavelength separator 5. Then, a portion to be machined is irradiated with the ultraviolet laser beam 2td, while the mixed wave 7 is incident on the corresponding laser attenuator 6 so as to be converted into heat.

Each ultraviolet laser beam 2td is positioned in a desired position by the corresponding laser positioning unit 20 so as to machine a work.

Next, the invention will be described using specific numerical values.

Nowadays, a laser oscillator with an average output power of about 20 W is put into practical use as the solid-state laser oscillator 1 for outputting the fundamental wave 2a with a wavelength of 0.7-2 μm. Pulse energy density of about 1 J/cm² in a portion to be machined is required to machine a hole with a diameter of 50 μm in a resin portion of a printed circuit board.

For example, when a portion to be machined is irradiated with an ultraviolet laser beam with a wavelength of 355 nm, a pulse width of several tens of nanoseconds and a pulse repetition frequency of 50 kHz, it will go well if the average output power is set at 1.5 W so as to set the energy density at 1 J/cm².

Assume now that the efficiency in converting the fundamental wave 2a into the ultraviolet laser beam 2t is 30%. In order to form an ultraviolet laser beam with an average output power of 1.5 W, it will go well if the fundamental wave 2a (1,064 nm in wavelength) with an average output power of 5 W is supplied to the wavelength converter 3. Therefore, when, for example, a laser oscillator with an average output power of 20 W is used as the laser oscillator 1, three or four ultraviolet laser beams 2t can be formed concurrently.

When the average power of the incident fundamental wave 2a is about 5 W, the temperature rise in each wavelength converter 3, 4 is so slight that the conversion performance thereof is rarely lowered. Accordingly, when the invention is applied, the lives of the wavelength converters 3 and 4 are prolonged so that the machining efficiency can be improved, and the running cost can be reduced.

On the other hand, when the same machining is performed in the background art, there is experimentally no problem as to the life of the wavelength converter 3, but the wavelength converter 4 has a short life. It is therefore necessary to frequently exchange the wavelength converter 4 for a new one so that the machining efficiency doesn't deteriorate. In addition, in some way of use, the wavelength converter 4 may be damaged.

### EMBODIMENT 2

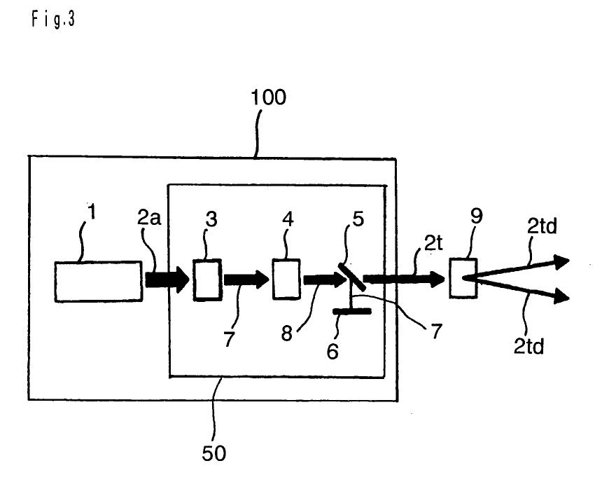

FIG. 2 is a main portion configuration diagram of a laser machining apparatus having a wavelength conversion unit according to a second embodiment of the invention. Parts the same as or functionally the same as those in FIGS. 1 and 3 are denoted by the same reference numerals correspondingly, and redundant description thereof will be omitted.

In this embodiment, there are provided a number of wavelength converters one larger than the number of ultraviolet laser beams to be output.

Next, the operation of this embodiment will be described.

A fundamental wave 2a output from a laser oscillator 1 is partially converted into a second harmonic 2b by a wavelength converter 3. A mixed wave 7 in which the fundamental wave 2a and the second harmonic 2b are mixed is separated into the second harmonic 2b and the fundamental wave 2a by a wavelength separator 5. The second harmonic 2b is incident on a laser distribution unit 9 so as to be branched into n (n≧2, 3 in FIG. 2) second harmonics 2bd. The fundamental wave 2a is incident on a laser attenuator 6 so as to be converted into heat.

Each branched second harmonic 2bd is partially converted into a fourth harmonic 2fb whose wavelength is ¼ of the wavelength of the fundamental wave 2a (the wavelength of the fourth harmonic 2fb is 266 nm when the wavelength of the fundamental wave 2a is 1,064 nm) by a corresponding wavelength converter 4. A laser beam output from each wavelength converter 4, in which the second harmonic 2bd and the fourth harmonic 2fd are mixed, is separated into the fourth harmonic 2fd and the second harmonic 2bd by a corresponding wavelength separator 5. Then, a portion to be machined is irradiated with the fourth harmonic 2fd, while the second harmonic 2bd is incident on a corresponding laser attenuator 6 so as to be converted into heat.

The fourth harmonic 2fd has machining performance equal to or higher than that of the third harmonic 2td. It is therefore possible to improve the machining performance.

All the fundamental wave 2a output from the laser oscillator 1 is incident on the wavelength converter 3. However, since the second harmonic 2b is output from the wavelength converter 3, no thermal damage will be caused even if the incident fundamental wave 2a has a high average output power.

In the aforementioned two embodiments, description has been made on the case where three ultraviolet laser beams are supplied to portions to be machined. However, the number of ultraviolet laser beams supplied to portions to be machined can be increased as long as the average output power of the laser oscillator 1 can be increased.

In the second embodiment, when the average output power of the laser oscillator 1 is larger than the capacity of the wavelength converter 3, a laser distribution unit 9 may be disposed between the laser oscillator 1 and the wavelength converter 3.

When a printed circuit board is machined by a laser beam, the practical wavelength thereof is 0.19-0.4 μm. Accordingly, it is practical that a laser oscillator outputting a laser beam with a wavelength of 0.76-1.6 μm is used as a near infrared laser.

1. A method for forming a plurality of laser beams with an ultraviolet wavelength, said ultraviolet-wavelength laser beams being formed by wavelength conversion of a laser beam with a near infrared wavelength, said method comprising the steps of:
branching a laser beam with a near infrared wavelength or each of laser beams whose wavelength is ½ of said near infrared wavelength into a plurality of laser beams; and
converting wavelengths of said plurality of branched laser beams individually so as to form a plurality of laser beams with an ultraviolet wavelength.

2. A method for forming a plurality of laser beams with an ultraviolet wavelength according to claim 1, wherein said ultraviolet wavelength of said formed laser beams is ⅓ or ¼ of said near infrared wavelength of said laser beam.

3. An apparatus for forming a plurality of laser beams with an ultraviolet wavelength, comprising:
a laser oscillator for outputting a first laser beam with a near infrared wavelength;
a branching means for branching said first laser beam into a plurality of branched first laser beams;
first wavelength conversion means for converting a part of said branched first laser beams into second laser beams whose wavelength is ½ of said near infrared wavelength of said first laser beam; and
second wavelength conversion means for forming laser beams with an ultraviolet wavelength which is ⅓ of said near infrared wavelength of said first laser beam, out of said second laser beams output from said first wavelength conversion means and said branched first laser beams which have not been converted in wavelength by said first wavelength conversion means; wherein:
after said first laser beam is branched into a plurality of branched first laser beams by said branching means, said plurality of branched first laser beams are formed into laser beams with an ultraviolet wavelength individually by said first and second wavelength conversion means.

4. An apparatus for forming a plurality of laser beams with an ultraviolet wavelength, comprising:
a laser oscillator for outputting a first laser beam with a near infrared wavelength;
two wavelength conversion means for converting said first laser beam incident thereon into a laser beam whose wavelength is ½ of said near infrared wavelength of said first laser beam; and
a branching means for branching an incident laser beam into a plurality of laser beams; wherein
said first laser beam with said near infrared wavelength is converted into a second laser beam whose wavelength is ½ of said near infrared wavelength by one of said wavelength conversion means;
said second laser beam is then branched into a plurality of branched second laser beams by said branching means; and
said branched second laser beams are formed into laser beams with an ultraviolet wavelength which is ½ of said wavelength of said second laser beam by the other wavelength conversion means.

5. A laser machining apparatus comprising:
a laser oscillator for outputting a first laser beam with a near infrared wavelength;
a plurality of pieces of forming apparatus for forming a plurality of laser beams with an ultraviolet wavelength according to claim 3; and
laser positioning means; wherein:
said first laser beam with said near infrared wavelength output from said laser oscillator is formed into a plurality of laser beams with an ultraviolet wavelength by said forming apparatus, and said plurality of formed laser beams with said ultraviolet wavelength are positioned individually by said positioning means so as to perform machining.

6. A laser machining apparatus comprising:
a laser oscillator for outputting a first laser beam with a near infrared wavelength;
a plurality of pieces of forming apparatus for forming a plurality of laser beams with an ultraviolet wavelength according to claim 4; and
laser positioning means; wherein:
said first laser beam with said near infrared wavelength output from said laser oscillator is formed into a plurality of laser beams with an ultraviolet wavelength by said forming apparatus, and said plurality of formed laser beams with said ultraviolet wavelength are positioned individually by said positioning means so as to perform machining.
